(19) United States
(12) Patent Application Publication
(10) Pub. No.: US 2025/0045475 A1
(43) Pub. Date: Feb. 6, 2025

(54) DEVICE AND METHOD FOR AUTOMATICALLY PLACING RACKS

(71) Applicants: Hyundai Motor Company, Seoul (KR); Kia Corporation, Seoul (KR)

(72) Inventors: Sunjoo Moon, Suwon-si (KR); Wonseok Choi, Seongnam-si (KR); Hyejun Park, Seoul (KR)

(21) Appl. No.: 18/524,286

(22) Filed: Nov. 30, 2023

(30) Foreign Application Priority Data
Jul. 31, 2023 (KR) 10-2023-0099816

(51) Int. Cl. G06F 30/13

(52) U.S. Cl. CPC G06F 30/13

(57) ABSTRACT

An embodiment device for automatically placing racks includes a rack modeling providing module configured to provide 3D modeling of the racks, a space modeling providing module configured to provide 3D modeling of a rack placement space, a rack placement interval input module configured to receive a rack placement interval, and an automatic rack placing module configured to automatically place the racks by copying the racks into the rack placement space in accordance with the rack placement interval with respect to a reference rack based on the reference rack being selected.

### CROSS-REFERENCE TO RELATED APPLICATIONS

This application claims the benefit of Korean Patent Application No. 10-2023-0099816, filed on Jul. 31, 2023, which application is hereby incorporated herein by reference.

### TECHNICAL FIELD

The disclosure relates to a device and method for automatically placing racks.

### BACKGROUND

With the progression of an industrialized society, the production of goods has increased, trade has gradually expanded, and there has been a significant increase in interest in not only the production but also the distribution of goods. In order to improve the distribution structure, logistics parks are being established, and interest in logistics and storage facilities is also increasing. In general, a logistics warehouse may be a storage facility for temporary or long-term storage of goods or raw materials produced by a producer, such as a manufacturer. With the development of road transportation, the emergence of retailers such as large discount stores and home shopping, and the activation of the home delivery industry, the role of logistics warehouses has increased, and the logistics warehouses have developed in the form of company-specific and retail-specific logistics centers with large-scale facilities. The logistics warehouses may use lifts, forklifts, and the like to transport and load goods to ensure efficient placement of goods, convenience for loading and unloading, and inventory management. In particular, a plurality of racks (or rack structures) each having a width and a height to or from which pallets may be loaded or unloaded may be used to make a logistics process efficient. Studies are being actively conducted on a rack placement simulation for spatial utilization in the logistics center.

### SUMMARY

Embodiments of the present invention provide a device and method for automatically placing racks, which are capable of quickly and automatically placing racks by establishing a 3D logistics center using a digital twin.

An exemplary embodiment of the present invention provides a device for automatically placing racks, the device including a rack modeling providing module configured to provide 3D modeling of racks, a space modeling providing module configured to provide 3D modeling of a rack placement space, a rack placement interval input module configured to receive a rack placement interval, and an automatic rack placing module configured to automatically place the racks by copying the racks into the rack placement space in accordance with the rack placement interval with respect to a reference rack when the reference rack is selected.

In several embodiments, the racks may include first type racks and second type racks different in shape from the first type racks, the rack placement interval input module may receive a first rack placement interval related to the first type racks and a second rack placement interval related to the second type racks, and the automatic rack placing module automatically may place the first type racks by copying the first type racks into the rack placement space in accordance with the first rack placement interval with respect to a first reference rack selected from the first type racks.

In several embodiments, after the placement of the first type racks is completed, the automatic rack placing module may automatically place the second type racks by copying the second type racks into the rack placement space in accordance with the second rack placement interval with respect to a second reference rack selected from the second type racks.

In several embodiments, the device for automatically placing racks may further include a 2D drawing input module configured to receive a 2D drawing and a 2D drawing analyzing module configured to determine a reference rack from the 2D drawing and recognize the rack placement interval, in which the automatic rack placing module determines figures identical to the reference rack and automatically places the racks by copying the racks into the rack placement space in accordance with the rack placement interval with respect to the reference rack.

In several embodiments, the 2D drawing analyzing module may recognize lines using object recognition on the 2D drawing, designate lines corresponding to the reference rack from a user among the recognized lines, and recognize a figure, which is defined by the designated lines, as the reference rack.

In several embodiments, the racks may include first type racks and second type racks different in shape from the first type racks, the 2D drawing analyzing module may recognize a first rack placement interval related to the first type racks and a second rack placement interval related to the second type racks, and the automatic rack placing module may automatically place the first type racks by copying the first type racks into the rack placement space in accordance with the first rack placement interval with respect to a first reference rack selected from the first type racks.

In several embodiments, after the placement of the first type racks is completed, the automatic rack placing module may automatically place the second type racks by copying the second type racks into the rack placement space in accordance with the second rack placement interval with respect to a second reference rack selected from the second type racks.

Another exemplary embodiment of the present invention provides a method of automatically placing racks, the method including providing 3D modeling of racks, providing 3D modeling of a rack placement space, receiving a rack placement interval, and automatically placing the racks by copying the racks into the rack placement space in accordance with the rack placement interval with respect to a reference rack when the reference rack is selected.

In several embodiments, the racks may include first type racks and second type racks different in shape from the first type racks, the receiving of the rack placement interval may include receiving a first rack placement interval related to the first type racks and a second rack placement interval related to the second type racks, and the automatic placing of the racks may include automatically placing the first type racks by copying the first type racks into the rack placement space in accordance with the first rack placement interval with respect to a first reference rack selected from the first type racks.

In several embodiments, the automatic placing of the racks may include automatically placing the second type racks by copying the second type racks into the rack placement space in accordance with the second rack placement interval with respect to a second reference rack selected from the second type racks after the placement of the first type racks is completed.

In several embodiments, the method of automatically placing racks may further include receiving a 2D drawing and determining a reference rack from the 2D drawing and recognizing a rack placement interval, in which the automatic placing of the racks includes determining figures identical to the reference rack and automatically placing the racks by copying the racks into the rack placement space in accordance with the rack placement interval with respect to the reference rack.

In several embodiments, the recognizing of the rack placement interval may include recognizing lines using object recognition on the 2D drawing, designating lines corresponding to the reference rack from a user among the recognized lines, and recognizing a figure, which is defined by the designated lines, as the reference rack.

In several embodiments, the racks may include first type racks and second type racks different in shape from the first type racks, the recognizing of the rack placement interval may include recognizing a first rack placement interval related to the first type racks and a second rack placement interval related to the second type racks, and the automatic placing of the racks may include automatically placing the first type racks by copying the first type racks into the rack placement space in accordance with the first rack placement interval with respect to a first reference rack selected from the first type racks.

In several embodiments, the automatic placing of the racks may include automatically placing the second type racks by copying the second type racks into the rack placement space in accordance with the second rack placement interval with respect to a second reference rack selected from the second type racks after the placement of the first type racks is completed.

According to the embodiments, when the user selects the reference rack, the racks are automatically copied and placed in the placement space in accordance with the predetermined placement interval, such that the racks may be conveniently, quickly, and automatically placed at the time of establishing the 3D logistics center using the digital twin. Therefore, the time required to establish the 3D logistics center may be shortened. The method according to the embodiments may be applied to place the identical products in various ways, instead of the racks, thereby making it easy to perform the placement. Furthermore, because the placement intervals may be flexibly changed, various types of design may be quickly and easily performed, unlike the standardized method in the related art.

### BRIEF DESCRIPTION OF THE DRAWINGS

FIG. 1 is a block diagram for explaining a device for automatically placing racks according to an embodiment.

FIG. 2 is a view illustrating a result of automatically placing racks according to an embodiment.

FIG. 3 is a flowchart for explaining a method of automatically placing racks according to an embodiment.

FIG. 4 is a block diagram for explaining the device for automatically placing racks according to an embodiment.

FIGS. 5 and 6 are views for explaining an operation of the device for automatically placing racks according to an embodiment.

FIG. 7 is a view for explaining a computing device according to an embodiment.

### DETAILED DESCRIPTION OF ILLUSTRATIVE EMBODIMENTS

Hereinafter, embodiments of the present invention will be described in detail with reference to the accompanying drawings so that those with ordinary skill in the art to which the present invention pertains may easily carry out the embodiments. However, embodiments of the present invention may be implemented in various different ways and are not limited to the embodiments described herein. Further, a part irrelevant to the description will be omitted in the drawings in order to clearly describe embodiments of the present invention, and similar constituent elements will be designated by similar reference numerals throughout the specification.

Throughout the specification and claims, unless explicitly described to the contrary, the word “comprise” or “include” and variations, such as “comprises”, “comprising”, “includes” or “including”, will be understood to imply the inclusion of stated constituent elements, not the exclusion of any other constituent elements. The terms including ordinal numbers such as “first,” “second,” and the like may be used to describe various constituent elements, but the constituent elements are not limited by the terms. These terms are used only to distinguish one constituent element from another constituent element.

The term “unit”, “part”, “module”, or the like, which is described in the specification, may mean a unit that may perform at least one function or operation described in the present specification, and the “unit”, “part”, “module”, or the like may be implemented by hardware, circuits, software, or a combination of hardware, circuits, and software. In addition, a configuration or function of at least a part of a device and method for automatically placing racks according to embodiments to be described below may be implemented as a program or software, and the program or software may be stored in a computer-readable medium.

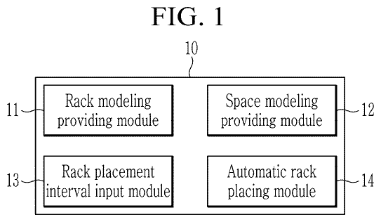

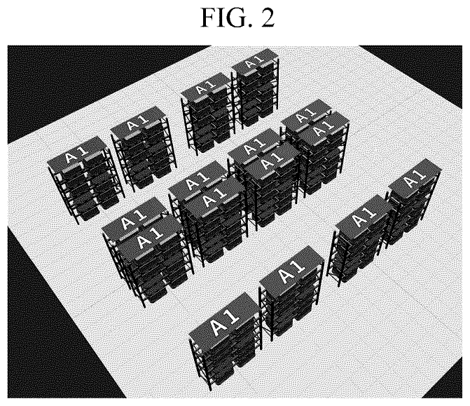

FIG. 1 is a block diagram for explaining a device for automatically placing racks according to an embodiment, and FIG. 2 is a view illustrating a result of automatically placing racks according to an embodiment.

With reference to FIG. 1, a device 10 for automatically placing racks according to an embodiment may automate rack placement in case that a 3D logistics center is established using a digital twin. To this end, the device 10 for automatically placing racks may include a rack modeling providing module 11, a space modeling providing module 12, a rack placement interval input module 13, and an automatic rack placing module 14.

The rack modeling providing module 11 may provide 3D modeling of the rack. Specifically, the rack modeling providing module 11 may provide a three-dimensional object of the rack that includes vertices, edges, and faces and defines how these elements are placed in a 3D space. In several embodiments, the 3D modeling of the rack may implement pallets, load beams, connection portions between the load beams and frame columns, the frame columns, supports, and the like and be generated on the basis of a predefined calculation formula that determines sizes and placement positions of the above-mentioned components.

The space modeling providing module 12 may provide 3D modeling of a rack placement space. Specifically, the rack placement space may mean a space of the logistics center. Positions of passageways, warehouses, unloading areas, packing areas, and the like may be defined in the logistics center. In addition, a size and shape of the logistics center, a position of an inlet, a position of an outlet, a movement route of goods, and the like may be considered. In consideration of the above-mentioned configurations, the space modeling providing module 12 may provide a three-dimensional object of the rack placement space that defines how the elements including vertices, edges, and faces are placed in the space of the logistics center.

The rack placement interval input module 13 may receive a rack placement interval. The rack placement interval may be determined depending on a condition that needs to be considered from the types of facility layouts, equipment, machines, and the like of the logistics center to be applied. In several embodiments, the rack placement interval input module 13 may receive the rack placement interval (Dₓ, D_{y}) defined by a first axis (x-axis) direction and a second axis (y-axis) direction perpendicular to the first axis direction.

Of course, in several embodiments, the rack placement interval input module 13 may receive a plurality of rack placement intervals, and the plurality of rack placement intervals may respectively correspond to several regions of the logistics center. For example, the rack placement interval may be defined as (Dₓ₁, D_{y1}) in a first region in which a passageway of the logistics center is positioned, the rack placement interval may be defined as (Dₓ₂, D_{y2}) in a second region corresponding to a warehouse in the logistics center, and the rack placement interval may be defined as (Dₓ₃, D_{y3}) in a third region corresponding to the unloading area in the logistics center.

For example, the automatic rack placing module 14 may display, on a display device, a reference rack in the 3D modeling of the racks provided by the rack modeling providing module 11 in the rack placement space provided by the space modeling providing module 12. The reference rack may be selected by a user input such as a touch input or a mouse input. When the reference rack is selected, the automatic rack placing module 14 may automatically place the racks by copying the racks into the rack placement space in accordance with the rack placement interval determined on the basis of the selected reference rack. FIG. 2 illustrates the result of automatically placing the racks by copying the racks in the rack placement space with respect to the reference rack. It can be seen that the placement intervals are differently determined for each of the regions such as the region in which the passageway is positioned or the region in which the passageway is not positioned.

In several embodiments, the rack placement intervals may be differently set for each of the racks having different shapes. Specifically, the racks may include first type racks and second type racks different in shape from the first type racks. The rack placement interval input module 13 may receive a first rack placement interval related to the first type racks and a second rack placement interval related to the second type racks. Further, the automatic rack placing module 14 may automatically place the first type racks by copying the first type racks into the rack placement space in accordance with the first rack placement interval with respect to a first reference rack selected from the first type racks. After the placement of the first type racks is completed, the automatic rack placing module 14 may automatically place the second type racks by copying the second type racks in the rack placement space in accordance with the second rack placement interval with respect to a second reference rack selected from the second type racks.

In this case, in order to set intervals between the first type racks, which have been already placed, and the second type racks to be placed, the rack placement interval input module 13 may display a user interface, which may select three types of options, on the display device. The corresponding user interface may include an option for allowing the user to use a first rack placement interval as the interval between the first type rack, which has been already placed, and the second type rack to be placed, an option for allowing the user to use a second rack placement interval, and an option for allowing the user to use an interval predetermined by the user. The user may only simply select one of the three types of options after the placement of the first type racks is completed, such that the intervals between the first type racks and the second type racks may be determined, and then the second type racks may be placed, thereby improving the convenience.

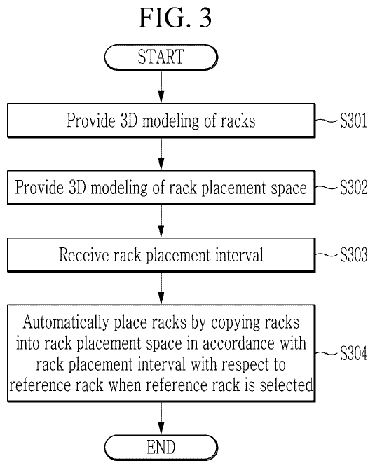

FIG. 3 is a flowchart for explaining a method of automatically placing racks according to an embodiment.

With reference to FIG. 3, the method of automatically placing racks according to an embodiment may include step S301 of providing the 3D modeling of the racks, step S302 of providing the 3D modeling of the rack placement space, step S303 of receiving the rack placement interval, and step S304 of automatically placing the racks by copying the racks into the rack placement space in accordance with the rack placement interval with respect to the reference rack when the reference rack is selected.

Because the specific details of the method of automatically placing racks may be described with reference to the description of the embodiments disclosed in the present specification, a repeated description will be omitted.

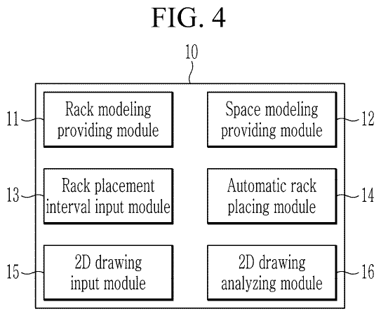

FIG. 4 is a block diagram for explaining the device for automatically placing racks according to an embodiment.

With reference to FIG. 4, the device 10 for automatically placing racks according to an embodiment may include the rack modeling providing module 11, the space modeling providing module 12, the rack placement interval input module 13, the automatic rack placing module 14, a 2D drawing input module 15, and a 2D drawing analyzing module 16. The detailed description of the rack modeling providing module 11, the space modeling providing module 12, the rack placement interval input module 13, and the automatic rack placing module 14 may be made with reference to the above-mentioned description related to FIG. 1 within a range that is not inconsistent with the present embodiment. Therefore, the description will be focused on the 2D drawing input module 15 and the 2D drawing analyzing module 16.

The 2D drawing input module 15 may receive a 2D drawing. The 2D drawing may be a top plan view of the elements, such as the racks, that constitute the interior of the logistics center. The 2D drawing analyzing module 16 may determine the reference rack from the 2D drawing and recognize the rack placement interval. In this case, the automatic rack placing module 14 may determine figures identical to the reference rack on the 2D drawing and automatically place the racks by copying the racks in the rack placement space in accordance with the rack placement interval recognized from the 2D drawing with respect to the reference rack.

In several embodiments, the 2D drawing analyzing module 16 may recognize lines using object recognition on the 2D drawing, designate lines corresponding to the reference rack from the user among the recognized lines, and recognize a figure, which is defined by the designated lines, as the reference rack.

Meanwhile, in several embodiments, the racks may include the first type racks and the second type racks different in shape from the first type racks, and the 2D drawing analyzing module 16 may recognize the first rack placement interval related to the first type racks and the second rack placement interval related to the second type racks. Further, the automatic rack placing module 14 may automatically place the first type racks by copying the first type racks into the rack placement space in accordance with the first rack placement interval with respect to the first reference rack selected from the first type racks. After the placement of the first type racks is completed, the automatic rack placing module 14 may automatically place the second type racks by copying the second type racks in the rack placement space in accordance with the second rack placement interval with respect to the second reference rack selected from the second type racks.

In this case, in order to set intervals between the first type racks, which have been already placed, and the second type racks to be placed, the rack placement interval input module 13 may display the user interface, from which a user may select one of the three types of options, on the display device. The corresponding user interface may include the option for allowing the user to use a first rack placement interval as the interval between the first type rack, which has been already placed, and the second type rack to be placed, the option for allowing the user to use a second rack placement interval, and the option for allowing the user to use an interval predetermined by the user. The user may only simply select one of the three types of options after the placement of the first type racks is completed, such that the intervals between the first type racks and the second type racks may be determined, and then the second type racks may be placed, thereby improving the convenience.

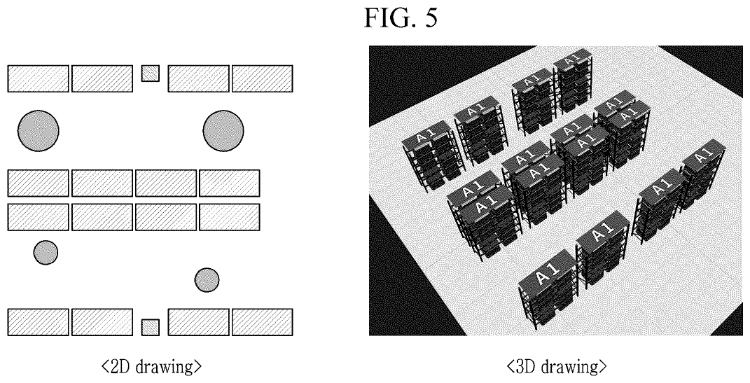

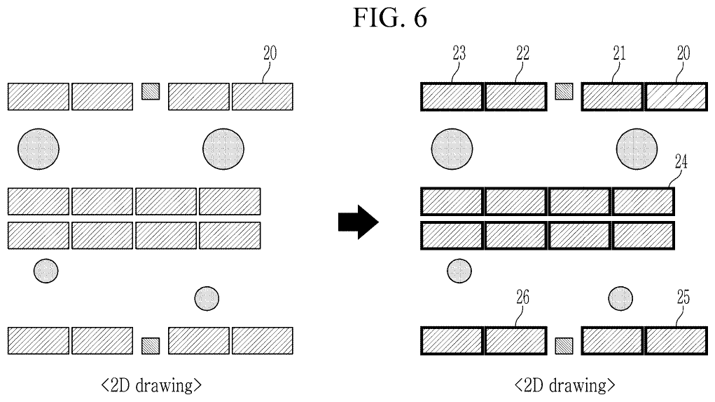

FIGS. 5 and 6 are views for explaining an operation of the device for automatically placing racks according to the embodiment.

With reference to FIG. 5, the left view is a 2D drawing of the logistics center, and the right view illustrates a result of automatically generating the racks on the basis of the corresponding 2D drawing.

With reference to FIG. 6, the left view is an inputted 2D drawing, and the right view illustrates a process of recognizing an object on the 2D drawing. That is, the 2D drawing analyzing module 16 may recognize lines using object recognition on the 2D drawing and thicken the lines to show the recognition result to the user, for example. The user may designate the line corresponding to a reference rack 20 among the recognized lines, and the figure, which is defined by the designated lines, may be recognized as the reference rack 20. Thereafter, the automatic rack placing module 14 may determine FIGS. 21, 22, 23, 24, 25, and 26 identical to the reference rack 20 on the 2D drawing and automatically place the racks by copying the racks into the 3D rack placement space in accordance with the rack placement interval recognized from the 2D drawing with respect to the reference rack 20. In this case, the same rack placement interval may be set between the FIGS. 20 and 21 and between the FIGS. 22 and 23, and different rack placement intervals may be set between the FIGS. 24, 25, and 26.

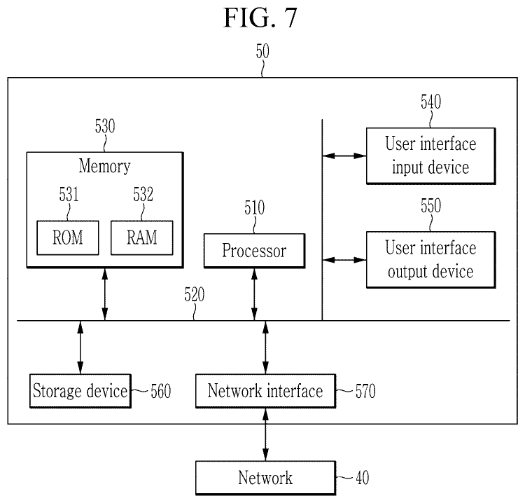

FIG. 7 is a view for explaining a computing device according to an embodiment.

With reference to FIG. 7, the device and method for automatically placing racks for a vehicle according to the embodiments may be implemented by using a computing device 50.

The computing device 50 may include at least one of a processor 510, a memory 530, a user interface input device 540, a user interface output device 550, and a storage device 560 that communicate with one another via a bus 520. The computing device 50 may also include a network interface 570 electrically connected to a network 40. The network interface 570 may transmit or receive a signal to or from another object through the network 40.

The processor 510 may be implemented by various types such as a micro-controller unit (MCU), an application processor (AP), a central processing unit (CPU), a graphic processing unit (GPU), a neural processing unit (NPU), and the like. The processor 510 may be any semiconductor device that executes instructions stored in the memory 530 or the storage device 560. The processor 510 may be configured to implement the functions and methods described above with reference to FIGS. 1 to 6.

The memory 530 and the storage device 560 may include various types of volatile or nonvolatile storage media. Examples of the memory may include a read-only memory (ROM) 531 and a random-access memory (RAM) 532. In the present embodiment, the memory 530 may be positioned inside or outside the processor 510, and the memory 530 may be connected to the processor 510 through various already known connections.

In several embodiments, the configuration or function of at least a part of the device and method for automatically placing racks for a vehicle according to the embodiments may be implemented as a program or software executed by the computing device 50, and the program or software may be stored in a computer-readable medium. Specifically, the computer-readable medium according to an embodiment may be a medium made by recording a program, which is stored in the memory 530 or the storage device 560, or a program, which is configured to execute the steps included in the method of automatically placing racks according to the embodiments, in a computer including the processor 510 for executing the instruction.

In several embodiments, a configuration or function of at least a part of the device and method for automatically placing racks for a vehicle according to the embodiments may be implemented by using the hardware or circuit of the computing device 50 or implemented as a separate hardware or circuit that may be electrically connected to the computing device 50.

According to the above-mentioned embodiments, when the user selects the reference rack, the racks are automatically copied and placed in the placement space in accordance with the predetermined placement interval, such that the racks may be conveniently, quickly, and automatically placed at the time of establishing the 3D logistics center using the digital twin. Therefore, the time required to establish the 3D logistics center may be shortened. The method according to the embodiments may be applied to place the identical products in various ways, instead of the racks, thereby making it easy to perform the placement. Furthermore, because the placement intervals may be flexibly changed, various types of design may be quickly and easily performed, unlike the standardized method in the related art.

Although the embodiments of the present invention have been described in detail above, the right scope of the present invention is not limited thereto, and it should be construed that many variations and modifications made by those skilled in the art using the basic concept of the present invention, which is defined in the following claims, will also belong to the right scope of the present invention.

What is claimed is:

1. A device for automatically placing racks, the device comprising:
a rack modeling providing a module configured to provide 3D modeling of the racks;
a space modeling providing a module configured to provide 3D modeling of a rack placement space;
a rack placement interval input module configured to receive a rack placement interval; and
an automatic rack placing module configured to automatically place the racks by copying the racks into the rack placement space in accordance with the rack placement interval with respect to a reference rack based on the reference rack being selected.

2. The device of claim 1, wherein:
the racks comprise first type racks and second type racks different in shape from the first type racks;
the rack placement interval input module is configured to receive a first rack placement interval related to the first type racks and a second rack placement interval related to the second type racks; and
the automatic rack placing module is configured to automatically place the first type racks by copying the first type racks into the rack placement space in accordance with the first rack placement interval with respect to a first reference rack selected from the first type racks.

3. The device of claim 2, wherein, after the placement of the first type racks is completed, the automatic rack placing module is configured to automatically place the second type racks by copying the second type racks into the rack placement space in accordance with the second rack placement interval with respect to a second reference rack selected from the second type racks.

4. The device of claim 1, further comprising:
a 2D drawing input module configured to receive a 2D drawing; and
a 2D drawing analyzing module configured to determine the reference rack from the 2D drawing and recognize the rack placement interval.

5. The device of claim 4, wherein the automatic rack placing module is configured to determine figures identical to the reference rack and automatically place the racks by copying the racks into the rack placement space in accordance with the rack placement interval with respect to the reference rack.

6. The device of claim 4, wherein the 2D drawing analyzing module is configured to:
recognize lines using object recognition on the 2D drawing;
designate lines corresponding to the reference rack selected by a user among the recognized lines; and
recognize a figure defined by the designated lines as the reference rack.

7. The device of claim 6, wherein:
the racks comprise first type racks and second type racks different in shape from the first type racks;
the 2D drawing analyzing module is configured to recognize a first rack placement interval related to the first type racks and a second rack placement interval related to the second type racks; and
the automatic rack placing module is configured to automatically place the first type racks by copying the first type racks into the rack placement space in accordance with the first rack placement interval with respect to a first reference rack selected from the first type racks.

8. The device of claim 7, wherein, after the placement of the first type racks is completed, the automatic rack placing module is configured to automatically place the second type racks by copying the second type racks into the rack placement space in accordance with the second rack placement interval with respect to a second reference rack selected from the second type racks.

9. A method of automatically placing racks, the method comprising:
providing 3D modeling of the racks;
providing 3D modeling of a rack placement space;
receiving a rack placement interval; and
automatically placing the racks by copying the racks into the rack placement space in accordance with the rack placement interval with respect to a reference rack in response to the reference rack being selected.

10. The method of claim 9, wherein:
the racks comprise first type racks and second type racks different in shape from the first type racks;
receiving the rack placement interval comprises receiving a first rack placement interval related to the first type racks and a second rack placement interval related to the second type racks; and
automatically placing the racks comprises automatically placing the first type racks by copying the first type racks into the rack placement space in accordance with the first rack placement interval with respect to a first reference rack selected from the first type racks.

11. The method of claim 10, wherein automatically placing the racks comprises automatically placing the second type racks by copying the second type racks into the rack placement space in accordance with the second rack placement interval with respect to a second reference rack selected from the second type racks after the placement of the first type racks is completed.

12. The method of claim 9, further comprising:
receiving a 2D drawing; and
determining the reference rack from the 2D drawing and recognizing the rack placement interval.

13. The method of claim 12, wherein automatically placing the racks comprises determining figures identical to the reference rack and automatically placing the racks by copying the racks into the rack placement space in accordance with the rack placement interval with respect to the reference rack.

14. The method of claim 12, wherein recognizing the rack placement interval comprises:
recognizing lines using object recognition on the 2D drawing;
designating lines corresponding to the reference rack selected by a user among the recognized lines; and
recognizing a figure defined by the designated lines as the reference rack.

15. The method of claim 14, wherein:
the racks comprise first type racks and second type racks different in shape from the first type racks;
recognizing the rack placement interval comprises recognizing a first rack placement interval related to the first type racks and a second rack placement interval related to the second type racks; and
automatically placing the racks comprises automatically placing the first type racks by copying the first type racks into the rack placement space in accordance with the first rack placement interval with respect to a first reference rack selected from the first type racks.

16. The method of claim 15, wherein automatically placing the racks comprises automatically placing the second type racks by copying the second type racks into the rack placement space in accordance with the second rack placement interval with respect to a second reference rack selected from the second type racks after the placement of the first type racks is completed.

17. A system for automatically placing racks, the system comprising:
a plurality of racks comprising first type racks and second type racks different in shape from the first type racks;
a rack modeling providing module configured to provide 3D modeling of the racks;
a space modeling providing module configured to provide 3D modeling of a rack placement space;
a rack placement interval input module configured to receive a first rack placement interval related to the first type racks and a second rack placement interval related to the second type racks;
an automatic rack placing module configured to automatically place the first type racks by copying the first type racks into the rack placement space in accordance with the first rack placement interval with respect to a first reference rack selected from the first type racks;
a 2D drawing input module configured to receive a 2D drawing; and
a 2D drawing analyzing module configured to determine the first reference rack from the 2D drawing and recognize the first rack placement interval.

18. The system of claim 17, wherein the automatic rack placing module is configured to determine figures identical to the first reference rack and automatically place the racks by copying the racks into the rack placement space in accordance with the first rack placement interval with respect to the first reference rack.

19. The system of claim 17, wherein the 2D drawing analyzing module is configured to:
recognize lines using object recognition on the 2D drawing;
designate lines corresponding to the first reference rack selected by a user among the recognized lines; and
recognize a figure defined by the designated lines as the first reference rack.

20. The system of claim 19, wherein, after the placement of the first type racks is completed, the automatic rack placing module is configured to automatically place the second type racks by copying the second type racks into the rack placement space in accordance with the second rack placement interval with respect to a second reference rack selected from the second type racks.
